(19) United States
(12) Patent Application Publication
(10) Pub. No.: US 2025/0217564 A1
(43) Pub. Date: Jul. 3, 2025

(54) CIRCUIT QUALITY CONFIRMATION APPARATUS AND CIRCUIT QUALITY CONFIRMATION METHOD

(71) Applicant: Mitsubishi Electric Corporation, Tokyo (JP)

(72) Inventors: Kousei SUZUKI, Tokyo (JP); Susumu HIRANO, Tokyo (JP)

(73) Assignee: Mitsubishi Electric Corporation, Tokyo (JP)

(21) Appl. No.: 19/082,998

(22) Filed: Mar. 18, 2025

Related U.S. Application Data
(63) Continuation of application No. PCT/JP2022/042042, filed on Nov. 11, 2022.

(51) Int. Cl. G06F 30/3312; G06F 30/35; G06F 119/12

(52) U.S. Cl. CPC G06F 30/3312; G06F 30/35; G06F 2119/12

(57) ABSTRACT

A circuit quality confirmation apparatus (10) includes a worst condition calculation unit (11) and a static validation tool execution unit (12). The worst condition calculation unit (11) calculates, using a dedicated timing constraint (21) that indicates an upper limit of a wiring delay value of an asynchronous clock interface path in an embedded circuit in which an asynchronous clock interface circuit where an input/output waveform of a signal is uniquely defined in accordance with a timing condition that is set is embedded, a worst condition (22). The worst condition (22) is a timing condition that is a theoretical limit of data that can be taken in in a subsequent stage of the asynchronous clock interface path in the embedded circuit, and that is a timing condition that is calculated based on a wiring delay in a post-layout netlist corresponding to the embedded circuit, and delay time corresponding to a deviation in timing of a signal. The static validation tool execution unit (12) validates quality of the embedded circuit by executing a static validation tool using the worst condition (22) that is calculated.

### CROSS REFERENCE TO RELATED APPLICATION

This application is a Continuation of PCT International Application No. PCT/JP2022/042042, filed on Nov. 11, 2022, which is hereby expressly incorporated by reference into the present application.

### TECHNICAL FIELD

The present disclosure relates to a circuit quality confirmation apparatus and a circuit quality confirmation method.

### BACKGROUND ART

The number of defects that occur in an asynchronous clock interface circuit is high in LSI (Large Scale Integration) design. There is no method in existing technology, however, to precisely and thoroughly confirm quality of a circuit in which the asynchronous clock interface circuit is embedded. Therefore, quality of the asynchronous clock interface circuit is often confirmed by a method such as waveform visualization, an RTL (Register Transfer Level) code review, or the like. With these methods, however, a confirmation load is heavy and an omission of confirmation is likely to occur.

Patent Literature 1 discloses technology that validates whether or not the asynchronous clock interface circuit operates normally by executing a simulation using an RTL of which has timing changed and comparing expected values. Non-Patent Literature 1 discloses technology that statically validates whether or not the asynchronous clock interface circuit operates normally by analyzing a circuit structure.

### CITATION LIST

### Patent Literature

Patent Literature 1: JP 2013-37596 A

### Non-Patent Literature

Non-Patent Literature 1: Nihon Synopsys G.K., “SpyGlassCDC”, [online], [searched on Apr. 19, 2022], Internet <URL: https://www.synopsys.com/ja-jp/verification/static-and-formal-verification/spyglass/spyglass-cdc.html>

### SUMMARY OF INVENTION

### Technical Problem

According to the technology that Patent Literature 1 discloses, in operation validation of a logic circuit that includes an asynchronous part, the logic circuit is validated by changing an RTL description of the asynchronous clock interface circuit, and then reproducing a delay difference of signals by increasing the number of synchronous flip-flop stages. Consequently, the quality of the asynchronous clock interface circuit can be confirmed with the technology. According to the technology, however, reproducing the delay difference is possible, but a delay value that is expected is not specifically defined. Here, a delay value that should actually be expected changes depending on a delay value after executing a layout corresponding to the logic circuit. Consequently, with the technology, there is a case where a delay value after a logic synthesis and a layout are executed exceeds the delay value that is expected even in a case where the asynchronous clock interface circuit is validated by the simulation. Consequently, there is no means in the technology to take the delay value after the layout is executed into consideration. Thus, there is an issue with the technology where rework occurs since validating the asynchronous clock interface circuit again is necessary in a case where the delay value after the layout is executed exceeded the delay value that is expected.

In a case where there are many number of bits and flip-flops to be added to the asynchronous clock interface circuit to be validated in the technology, there is an issue where time is needed for validation since a generation amount of RTLs exclusively for quality confirmation to be generated increases. Since the validation is executed using the RTL exclusively for quality confirmation and not an actual RTL, there is an issue where there is a possibility of mistaking the RTL exclusively for quality confirmation for the actual RTL.

According to technology that Non-Patent Literature 1 discloses, asynchronous validation can be executed statically and quickly by executing a structural analysis of an RTL at a validation stage. Specifically, with the technology, a circuit structure is analyzed with a setup file in which the RTL, timing information, a synchronous relationship between clocks, and the like are indicated as input, and validation for synchronization is executed. According to the technology, the asynchronous clock interface circuit is validated for each property such as delivering from a fast clock to a slow clock, checking a synchronous enable signal, and the like as functionality checks. Consequently, the technology makes validation by a static property check possible, and not validation based on a dynamic pattern. Thus, the technology can solve an issue in Patent Literature 1 arising from validation patterns increasing.

According to the technology, however, there is an issue where omission of validation occurs in a pattern of phases between asynchronous clocks that is not taken into consideration by a user since a pattern in the setup file designated by the user is used as the phases between asynchronous clocks when executing the validation. A typical static validation tool can only analyze on a clock cycle basis. Consequently, according to the technology, there is an issue where there is a possibility of an issue occurring depending on a delay situation after the layout even in a case where there was no issue in the validation since the delay situation after a layout such as a clock jitter, setup time, and the like cannot be taken into consideration.

The present disclosure aims, in design of a circuit that includes an asynchronous clock interface circuit, to reduce rework, validate using an actual RTL, reduce omission of validation relating to a pattern of phases between asynchronous clocks, and validate taking a delay situation after a layout into consideration.

### Solution to Problem

A circuit quality confirmation apparatus according to the present disclosure includes:
a worst condition calculation unit to calculate, using a dedicated timing constraint that indicates an upper limit of a wiring delay value of an asynchronous clock interface path in an embedded circuit in which a dedicated circuit that is an asynchronous clock interface circuit where an input/output waveform of a signal is uniquely defined in accordance with a timing condition that is set and that is an asynchronous clock interface circuit that includes an asynchronous clock interface path is embedded, a worst condition that is a timing condition that is a theoretical limit of data that can be taken in in a subsequent stage of the asynchronous clock interface path in the embedded circuit, and that is a timing condition that is calculated based on a wiring delay that is expected to occur in a post-layout netlist equivalent to a circuit that is generated by executing a layout corresponding to the embedded circuit, and delay time that occurs by at least one of a phase relationship between asynchronous clocks, a clock jitter, a clock skew, a setup time, and a hold time in the dedicated circuit; and
a static validation tool execution unit to validate quality of the embedded circuit by executing a validation tool that statically validates the quality of the embedded circuit using the embedded circuit, a timing constraint of the embedded circuit, and a worst condition that is calculated, wherein
each of the dedicated circuit that is the asynchronous clock interface circuit and the embedded circuit is a circuit expressed by a hardware description language.

### Advantageous Effects of Invention

According to the present disclosure, in validation of an embedded circuit in which a dedicated circuit that is an asynchronous clock interface circuit is embedded, the embedded circuit can be validated thoroughly since a worst condition is used. Here, the worst condition is a condition that is calculated taking a delay situation after a layout into consideration. The embedded circuit is an actual RTL. Thus, according to the present disclosure, in design of a circuit that includes the asynchronous clock interface circuit, rework can be reduced, validating using the actual RTL can be done, omission of validation relating to a pattern of phases between asynchronous clocks can be reduced, and validating can be done taking the delay situation after the layout into consideration.

### BRIEF DESCRIPTION OF DRAWINGS

FIG. 1 is a diagram illustrating an example of a configuration of a circuit quality confirmation system 90 according to Embodiment 1.

FIG. 2 is a diagram describing a CDC-IP 20 according to Embodiment 1.

FIG. 3 is a diagram describing a timing chart corresponding to the CDC-IP 20 according to Embodiment 1.

FIG. 4 is a diagram describing a timing chart corresponding to the CDC-IP 20 according to Embodiment 1.

FIG. 5 is a diagram illustrating an example of a hardware configuration of a circuit quality confirmation apparatus 10 according to Embodiment 1.

FIG. 6 is a flowchart illustrating operation of the circuit quality confirmation apparatus 10 according to Embodiment 1.

FIG. 7 is a diagram illustrating an example of a hardware configuration of a circuit quality confirmation apparatus 10 according to a variation of Embodiment 1.

FIG. 8 is a diagram illustrating an example of a configuration of a circuit quality confirmation system 90 according to Embodiment 2.

FIG. 9 is a diagram illustrating an example of a configuration of a circuit quality confirmation system 90 according to Embodiment 3.

FIG. 10 is a diagram describing a timing chart corresponding to a CDC-IP 20 according to Embodiment 3.

FIG. 11 is a diagram describing a timing chart corresponding to the CDC-IP 20 according to Embodiment 3.

FIG. 12 is a flowchart illustrating operation of a circuit quality confirmation apparatus 10 according to Embodiment 3.

FIG. 13 is a diagram illustrating an example of a configuration of a circuit quality confirmation system 90 according to Embodiment 4.

FIG. 14 is a diagram describing a CDC-IP 20 according to Embodiment 4.

### DESCRIPTION OF EMBODIMENTS

In a description of the embodiments and in drawings, same reference signs are added to same elements and corresponding elements. A description of elements having the same reference signs added will be suitably omitted or simplified. Arrows in diagrams mainly indicate flows of data or flows of processes. “Unit” may be suitably replaced with “circuit”, “step”, “procedure”, “process”, or “circuitry”.

### Embodiment 1

The present embodiment will be described in detail below while referring to the drawings.

### Description of Configuration

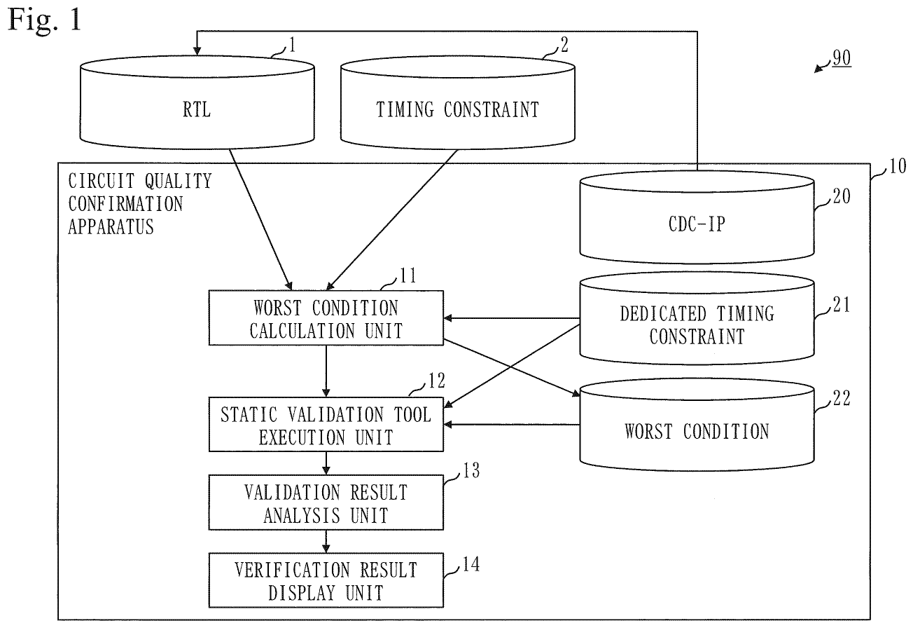

FIG. 1 illustrates an example of a configuration of a circuit quality confirmation system 90 according to the present embodiment. The circuit quality confirmation system 90, as illustrated in FIG. 1, includes an RTL 1, a timing constraint 2, and a circuit quality confirmation apparatus 10.

The circuit quality confirmation apparatus 10 is an apparatus for confirming quality of a target circuit. The circuit quality confirmation apparatus 10, as illustrated in FIG. 1, includes a worst condition calculation unit 11, a static validation tool execution unit 12, a validation result analysis unit 13, and a verification result display unit 14. The circuit quality confirmation apparatus 10 stores the RTL (Register Transfer Level) 1, the timing constraint 2, a CDC-IP 20, a dedicated timing constraint 21, and a worst condition 22.

The RTL 1 is an electronic circuit, and is also called a target circuit. The RTL 1 may be a netlist. The RTL 1 includes an asynchronous clock interface circuit.

The CDC-IP 20 is an asynchronous clock interface circuit where a timing condition for operation is uniquely defined by defining a relationship between data that is to be input and an enable that latches the data, and is an asynchronous clock interface circuit that includes an asynchronous clock interface path. The asynchronous clock interface path is also called an asynchronous clock interface. The CDC-IP 20 is a dedicated circuit. The dedicated circuit is an asynchronous clock interface circuit where an input/output waveform of a signal is uniquely defined in accordance with the timing condition that is set, and is an asynchronous clock interface circuit that includes the asynchronous clock interface path.

Each of the RTL 1 and the CDC-IP 20 is a circuit expressed by a typical hardware description language.

The timing constraint 2 indicates a timing constraint regarding a signal of the RTL 1.

The dedicated timing constraint 21 indicates a timing constraint regarding a signal of the CDC-IP 20, indicates a constraint relating to a circuit delay in the CDC-IP 20, indicates an upper limit of a wiring delay value of an asynchronous clock interface path in an embedded circuit 23, and is also called a CDC-IP dedicated timing constraint. The circuit delay is a generic term for a wiring delay and a condition relating to a deviation in timing of a signal. The condition relating to the deviation in the timing of the signal, specifically, is a condition corresponding to at least one of a phase relationship between asynchronous clocks, a clock jitter, a clock skew, a setup time, and a hold time. The deviation in the timing of the signal, basically, is defined by taking all of the phase relationship between asynchronous clocks, the clock jitter, the clock skew, the setup time, and the hold time into consideration. The setup time and the hold time are also called setup/hold values. The upper limit of the wiring delay value is a value that is expected as an upper limit of a wiring delay value in a post-layout netlist. The post-layout netlist is equivalent to a circuit that is generated by executing a layout corresponding to the embedded circuit 23, and is equivalent to a circuit after the layout corresponding to the embedded circuit 23. A post-layout netlist corresponding to the embedded circuit 23 is a netlist that is generated by completing a synthesis and arrangement and wiring corresponding to the embedded circuit 23. A delay is assigned to the post-layout netlist. Basically, a MaxDelay constraint is included in the dedicated timing constraint 21. The MaxDelay constraint is a timing constraint that sets an upper limit of a delay value for a path that is set, and is a timing constraint that is set taking an overall circuit delay into consideration.

Each of the timing constraint 2 and the dedicated timing constraint 21, as a specific example, is an SDC (Synopsys Design Constraints) file.

The worst condition 22 is a timing condition that is a theoretical limit of data that can be taken in in a subsequent stage of the asynchronous clock interface in the CDC-IP 20, a timing condition that is calculated based on a wiring delay that is expected to occur in the post-layout netlist and on delay time that occurs by a condition relating to a deviation of timing of a signal in the dedicated circuit, and a timing condition used when executing static validation in the static validation tool execution unit 12.

The embedded circuit 23 is a circuit expressed by a hardware description language, a circuit to be implemented in an integrated circuit, a circuit in which the dedicated circuit is embedded, and a circuit that is generated by embedding the CDC-IP 20 in the RTL 1. As a specific example, a designer of the RTL generates the embedded circuit 23 by embedding the CDC-IP 20 in the asynchronous clock interface circuit that the RTL 1 includes, or by replacing the asynchronous clock interface circuit that the RTL 1 includes with the CDC-IP 20. The embedded circuit 23 is also called an asynchronous clock interface embedded circuit.

An embedded constraint 24 is a timing constraint that is generated by embedding the dedicated timing constraint 21 in the timing constraint 2, and indicates timing of a signal in the embedded circuit 23. As a specific example, the designer of the RTL generates the embedded constraint 24 by suitably embedding the dedicated timing constraint 21 in the timing constraint 2.

The worst condition calculation unit 11 calculates the worst condition 22 using the embedded circuit 23 and the embedded constraint 24. Here, the dedicated timing constraint 21 is included in the embedded constraint 24.

The worst condition calculation unit 11 can uniquely define a relationship between data to be inputted to the embedded circuit 23 and the enable that performs latching of the data, and can decide on an upper limit of a delay value in the asynchronous clock interface path based on the dedicated timing constraint 21. The worst condition calculation unit 11 calculates the worst condition 22 by taking the wiring delay that is expected to occur in the post-layout netlist and a condition other than the wiring delay relating to the circuit delay into consideration. The condition other than the wiring delay relating to the circuit delay is the condition relating to the deviation in the timing of the signal. In a case where an upper limit value of the wiring delay that is expected to occur in the post-layout netlist is defined, the worst condition calculation unit 11 can calculate a condition for statically validating the asynchronous clock interface circuit by calculating the worst condition taking the upper limit value of the wiring delay that is defined and a condition other than the wiring delay into consideration. The worst condition calculation unit 11 may calculate the worst condition 22 based on a property of a signal that occurs in the embedded circuit 23 in a case where the embedded circuit 23 is implemented in a base.

The static validation tool execution unit 12 validates quality of the embedded circuit 23 by executing a validation tool that statically validates the quality of the embedded circuit 23 using the embedded circuit 23, a timing constraint of the embedded circuit 23, and the worst condition 22 that is calculated. At this time, the static validation tool execution unit 12 validates the quality of the embedded circuit 23 taking the deviation in timing due to at least one of the wiring delay in the post-layout netlist corresponding to the embedded circuit 23 and the condition relating to the deviation in the timing of the signal into consideration. The static validation tool execution unit 12 generates the embedded circuit 23 by replacing a target asynchronous clock interface circuit that is the asynchronous clock interface circuit that the target circuit includes with a dedicated circuit that is in accordance with an interface format of the target asynchronous clock interface circuit. The validation tool may be a commercially available tool, and as a specific example, is a tool indicated in Non-Patent Literature 1. The validation tool may be installed in the circuit quality confirmation apparatus 10, or may be installed in a different apparatus.

The validation result analysis unit 13 analyzes a result of the static validation tool execution unit 12 executing the validation tool.

The verification result display unit 14 displays the result that the validation result analysis unit 13 analyzed, and is also called a quality pass/fail verification display unit.

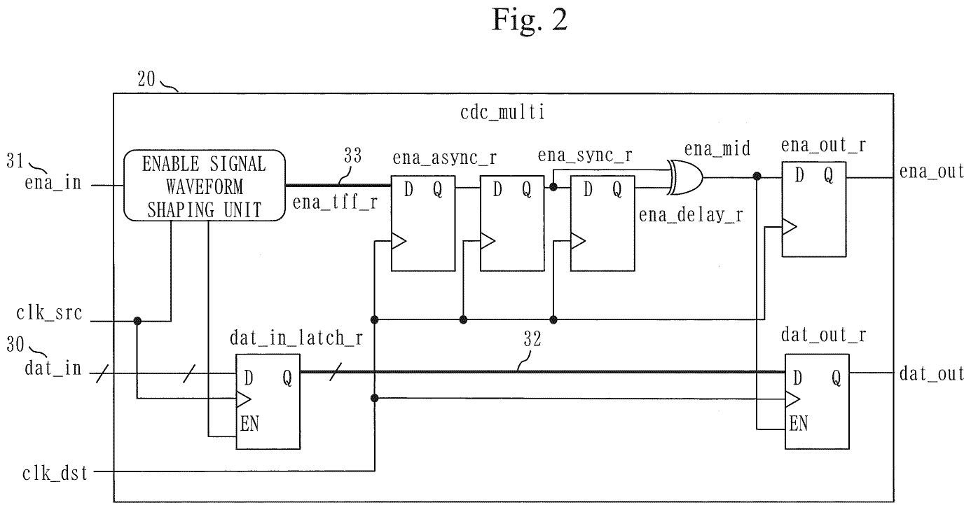

FIG. 2 illustrates a specific example of the CDC-IP 20 that is the asynchronous clock interface circuit. The asynchronous clock interface circuit is a circuit that is expressed by a hardware description language.

A signal 30 is an asynchronous data signal.

A signal 31 is an asynchronous enable signal for taking in the signal 30 in a subsequent stage of the asynchronous clock interface path in the CDC-IP 20.

In FIG. 2, asynchronous clock interface paths are a wiring 32 and a wiring 33. In FIG. 2, the subsequent stage of the asynchronous clock interface path is a flip-flop that takes in a signal that is transmitted through each of the wiring 32 and the wiring 33. There is a case where the subsequent stage of the asynchronous clock interface path in the CDC-IP 20 is written simply as the subsequent stage.

The wiring 32 is wiring that transmits the signal 30 whose waveform has been shaped.

The wiring 33 is wiring that transmits the signal 31 whose waveform has been shaped.

By suitably defining a timing constraint for each of the signal 30 and the signal 31, asynchronous data can reliably be taken in in the subsequent stage in a case where there is no delay in each signal. Timing of the CDC-IP 20 is uniquely decided on by suitably setting beforehand at least one of wiring delay values of the wiring 32 and the wiring 33, setup/hold values of the flip-flop, a clock skew value, a phase difference between asynchronous clocks, and the like.

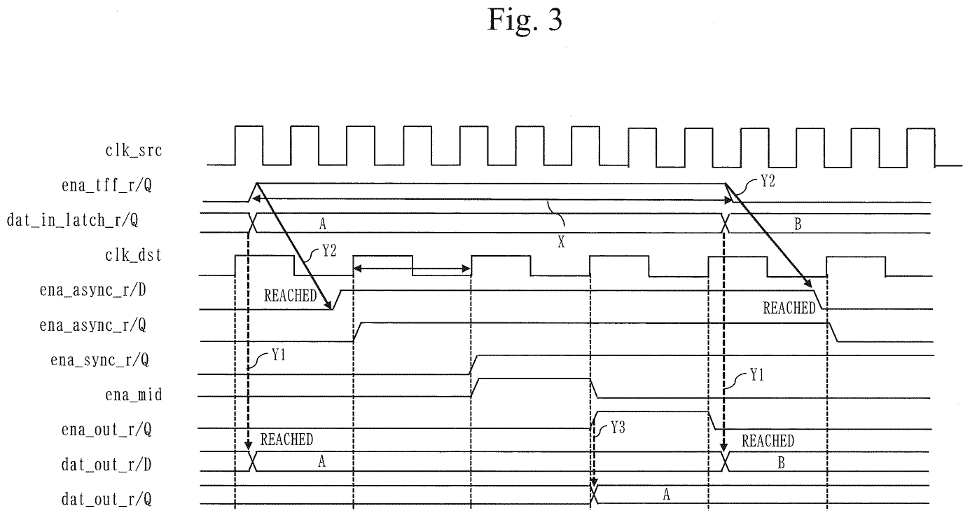

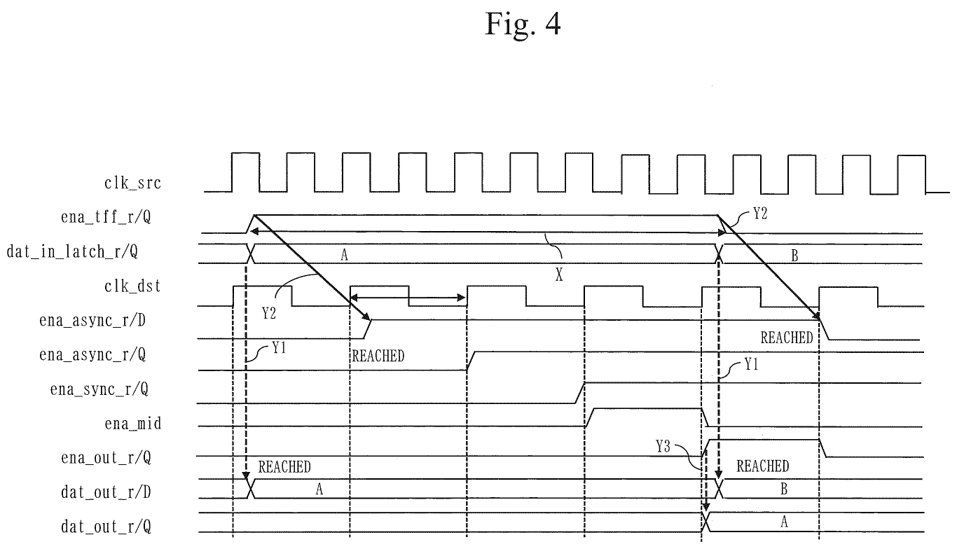

Each of FIG. 3 and FIG. 4 illustrates a timing chart corresponding to the CDC-IP 20 illustrated in FIG. 2. FIG. 3 and FIG. 4 illustrate that timing when data is latched in the subsequent stage of the asynchronous clock interface path in the CDC-IP 20 differ depending on a delay situation of the signal. Here, arrow Y1 indicates a delay of data (dat_in_latch_r). Arrow Y2 indicates a delay of an enable signal (ena_tff_r/Q). Maximum values of each of the delay that arrow Y1 indicates and the delay that arrow Y2 indicates are managed by the dedicated timing constraint 21. Arrow Y3 indicates how data (dat_out_r/D) is latched at timing when enable control (ena_mid) is High. Arrow X indicates a holding width of the enable signal (ena_tff_r/Q).

FIG. 3 illustrates a specific example in which a subsequent stage can latch data with a margin in a state where there is a data holding width that is indicated by arrow X.

FIG. 4 illustrates a specific example in which data could be latched at a last minute in a subsequent stage in a data holding width that is indicated by arrow X. In FIG. 4, relating to the enable signal (ena_tff_r/Q), one cycle's worth of delay is occurring on a receiving side compared with a case that is illustrated in FIG. 3. This delay happens in a case where latching of data could not be in time at the last minute when the enable signal reached the flip-flop.

Apart from notification of the enable signal being delayed due to the phase relationship between asynchronous clocks mentioned above, a delay due to a wiring delay occurs as indicated by a slope of arrow Y2. In a case where the wiring delay is not designated, the value of the wiring delay can be any value as a general rule. In a case where the wiring delay is large, a signal propagation to a subsequent stage is delayed as large as the wiring delay. Here, a wiring delay that is equal to or more than the wiring delay illustrated in FIG. 4 can be prevented by setting an upper value of the wiring delay for the enable signal (ena_tff_r/Q) using the dedicated timing constraint 21. As a result, the worst condition calculation unit 11 can calculate the worst condition 22.

In FIG. 4, a margin in timing of a data latch in the subsequent stage has become less as a result of the delay that occurred. And, when the enable signal (ena_tff_r/Q) is delayed further to a next cycle, data cannot be latched in the subsequent stage. Or, in a case where the data holding width as indicated by arrow X is short, data will be missed in the subsequent stage. That is, FIG. 4 illustrates a specific example of the worst condition 22 taking a delay value after a logic synthesis and the layout are executed into consideration.

The static validation tool execution unit 12 inputs the worst condition 22 in the validation tool, or sets the worst condition 22 in the validation tool. As a result, in the static validation tool execution unit 12, since validation based on the worst condition 22 becomes possible, and the embedded circuit 23 is validated taking the phase relationship between asynchronous clocks, the delay value or the like into consideration, an issue relating to thoroughness does not occur. By what is mentioned above, the circuit quality confirmation apparatus 10 can verify quality pass/fail relating to circuit operation regarding the embedded circuit 23.

The worst condition calculation unit 11 calculates the worst condition 22. Specifically, the worst condition calculation unit 11, by uniquely deciding on a waveform that is to be input/output in the CDC-IP 20 and by limiting the delay value of the asynchronous clock interface path by the dedicated timing constraint 21, calculates the worst condition 22 that indicates a holding period of the enable signal (ena_tff_r/Q) that is necessary for normal circuit operation. The holding period of the enable signal (ena_tff_r/Q) that is necessary for the normal circuit operation, as illustrated in FIG. 4, is such a period in which data is held until the enable signal (ena_tff_r/Q) reaches the flip-flop that latches the data on a receiving side.

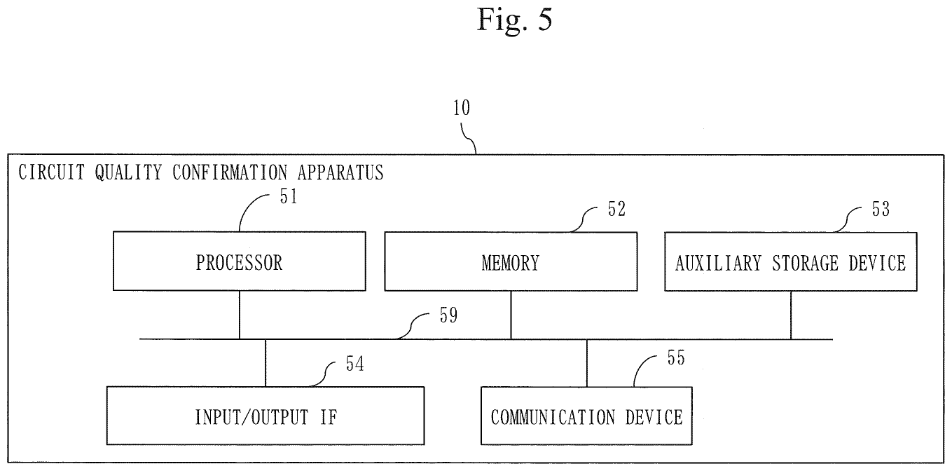

FIG. 5 illustrates an example of a hardware configuration of the circuit quality confirmation apparatus 10 according to the present embodiment. The circuit quality confirmation apparatus 10 consists of a computer. The circuit quality confirmation apparatus 10 may consist of a plurality of computers.

The circuit quality confirmation apparatus 10, as illustrated in the present diagram, is a computer that includes hardware such as a processor 51, a memory 52, an auxiliary storage device 53, an input/output IF (Interface) 54, a communication device 55, and the like. These pieces of hardware are suitably connected through a signal line 59.

The processor 51 is an IC (Integrated Circuit) that performs a calculation process, and controls hardware that the computer includes. The processor 51, as a specific example, is a CPU (Central Processing Unit), a DSP (Digital Signal Processor), or a GPU (Graphics Processing Unit).

The circuit quality confirmation apparatus 10 may include a plurality of processors that replace the processor 51. The plurality of processors share roles of the processor 51.

The memory 52 is typically a volatile storage device, and as a specific example, is a RAM (Random Access Memory). The memory 52 is also called a main storage device or a main memory. Data stored in the memory 52 is saved in the auxiliary storage device 53 as necessary.

The auxiliary storage device 53 is typically a non-volatile storage device, and as a specific example, is a ROM (Read Only Memory), an HDD (Hard Disk Drive), or a flash memory. Data stored in the auxiliary storage device 53 is loaded into the memory 52 as necessary.

The memory 52 and the auxiliary storage device 53 may be configured integrally.

The input/output IF 54 is a port to which an input device and an output device are connected. The input/output IF 54, as a specific example, is a USB (Universal Serial Bus) terminal. Input devices, as specific examples, are a keyboard and a mouse. The output device, as a specific example, is a display.

The communication device 55 is a receiver and a transmitter. The communication device 55, as a specific example, is a communication chip or an NIC (Network Interface Card).

Each unit of the circuit quality confirmation apparatus 10 may suitably use the input/output IF 54 and the communication device 55 when communicating with a different device and the like.

The auxiliary storage device 53 has stored a circuit quality confirmation program. The circuit quality confirmation program is a program that causes a computer to enable functions of each unit that the circuit quality confirmation apparatus 10 includes. The circuit quality confirmation program is loaded into the memory 52, and executed by the processor 51. The functions of each unit that the circuit quality confirmation apparatus 10 includes are enabled by software.

Data used when executing the circuit quality confirmation program, data obtained by executing the circuit quality confirmation program, and the like are suitably stored in a storage device. Each unit of the circuit quality confirmation apparatus 10 suitably utilizes the storage device. The storage device, as a specific example, consists of at least one of the memory 52, the auxiliary storage device 53, a register in the processor 51, and a cache memory in the processor 51. There is a case where a term “data” and a term “information” have an equal meaning. The storage device may be a device that is independent of the computer.

Functions of the memory 52 and the auxiliary storage device 53 may be enabled by a different storage device.

The circuit quality confirmation program may be recorded in a computer-readable non-volatile recording medium. The non-volatile recording medium, as a specific example, is an optical disc or a flash memory. The circuit quality confirmation program may be provided as a program product.

### Description of Operation

An operation procedure of the circuit quality confirmation apparatus 10 is equivalent to a circuit quality confirmation method. A program that enables operation of the circuit quality confirmation apparatus 10 is equivalent to the circuit quality confirmation program.

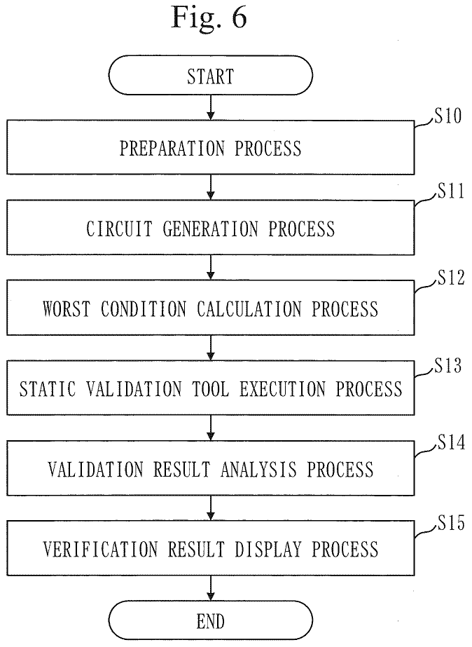

FIG. 6 is a flowchart illustrating an example of the operation of the circuit quality confirmation apparatus 10. The operation of the circuit quality confirmation apparatus 10 will be described using FIG. 6.

### (Step S10: Preparation Process)

The circuit quality confirmation apparatus 10 prepares a CDC-IP 20 corresponding to the asynchronous clock interface path that the RTL 1 includes, and the dedicated timing constraint 21.

### (Step S11: Circuit Generation Process)

In the present step, the embedded circuit 23 is generated by embedding the CDC-IP 20 in the RTL 1. In the present step, the embedded constraint 24 is generated by embedding the dedicated timing constraint 21 in the timing constraint 2.

### (Step S12: Worst Condition Calculation Process)

The worst condition calculation unit 11 calculates the worst condition 22 based on the CDC-IP 20 and the dedicated timing constraint 21.

### (Step S13: Static Validation Tool Execution Process)

The static validation tool execution unit 12 inputs the worst condition 22, the embedded circuit 23, and the embedded constraint 24 in a static validation tool, and validates the embedded circuit 23 using the static validation tool.

### (Step S14: Validation Result Analysis Process)

The validation result analysis unit 13 confirms the quality of the embedded circuit 23 by analyzing a result of the static validation tool execution unit 12 executing the static validation tool.

### (Step S15: Verification Result Display Process)

The verification result display unit 14 displays the result that the validation result analysis unit 13 analyzed.

### Description of Effect of Embodiment 1.

As described above, according to the present embodiment, patterns that must be validated in quality validation of the embedded circuit 23 can be thoroughly validated by using the embedded circuit 23 and the worst condition 22. According to the present embodiment, the quality pass/fail relating to whether or not the embedded circuit 23 operates normally can be automatically verified by using the static validation tool.

According to Patent Literature 1, an RTL for validation is generated for each pattern of delay for validating the RTL, and each RTL for validation that is generated is validated. Consequently, according to Patent Literature 1, although all patterns of delay of the RTL that have been expected can be validated using the RTL for validation, a pattern cannot be handled in a case where a delay that is equal to or greater than the delay that is expected happened after executing the layout. In Patent Literature 1, the RTL for validation increases in a case where there are a large number of bits of the asynchronous clock interface circuit to be validated, a case where the delay value that is expected becomes large, or the like. Consequently, simulation takes a tremendous amount of time and management of RTLs that are generated becomes complicated in these cases.

According to Non-Patent Literature 1, since static asynchronous validation is made possible by analyzing a circuit structure, time that is taken for the validation can be reduced. According to Non-Patent Literature 1, however, a phase difference between asynchronous clocks cannot be validated and a circuit cannot be validated taking a wiring delay and the like after implementation of a circuit into consideration. Consequently, there is an issue where there is a possibility of a defect being in the circuit even in a case where an error is not detected by a validation tool.

On the other hand, according to the present embodiment, the timing is uniquely decided on, and an upper limit of a delay that is expected by the dedicated timing constraint 21 is specified. Consequently, according to the present embodiment, the circuit can be statically validated by the validation tool by taking operation that has a relationship with signal timing intended by a designer of the circuit, and a worst timing condition that occur by the wiring delay after implementation of the circuit and the like into consideration, and the quality pass/fail regarding the circuit operation can be verified without generating a large number of RTLs for validation.

### Other Configurations

### <Variation 1>

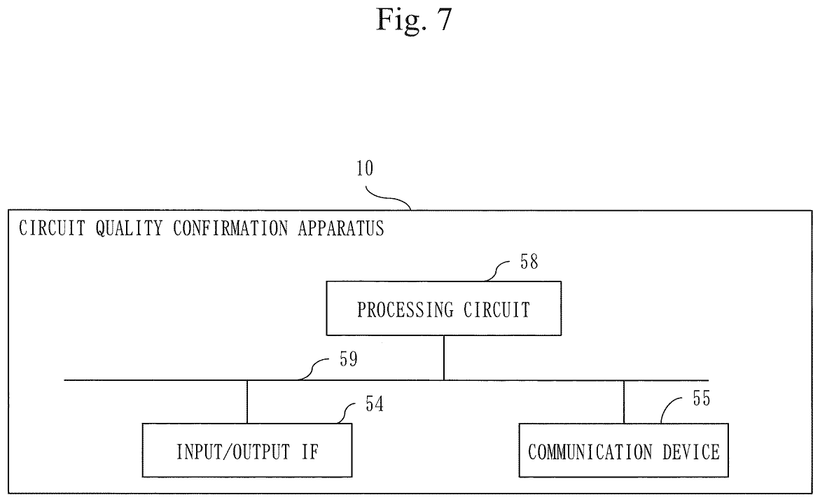

FIG. 7 illustrates an example of a hardware configuration of a circuit quality confirmation apparatus 10 according to the present variation.

The circuit quality confirmation apparatus 10 includes a processing circuit 58 instead of the processor 51, the processor 51 and the memory 52, the processor 51 and the auxiliary storage device 53, or the processor 51, the memory 52, and the auxiliary storage device 53.

The processing circuit 58 is hardware that enables at least a part of each unit that the circuit quality confirmation apparatus 10 includes.

The processing circuit 58 may be dedicated hardware and may be a processor that executes a program stored in the memory 52.

In a case where the processing circuit 58 is dedicated hardware, the processing circuit 58, as a specific example, is a single circuit, a composite circuit, a programmed processor, a parallel programmed processor, an ASIC (Application Specific Integrated Circuit), an FPGA (Field Programmable Gate Array), or a combination of these.

The circuit quality confirmation apparatus 10 may include a plurality of processing circuits that replace the processing circuit 58. The plurality of processing circuits share roles of the processing circuit 58.

In the circuit quality confirmation apparatus 10, some of functions may be enabled by dedicated hardware and the rest of the functions may be enabled by software or firmware.

The processing circuit 58, as a specific example, is enabled by hardware, software, firmware, or a combination of these.

The processor 51, the memory 52, the auxiliary storage device 53, and the processing circuit 58 are generically called “processing circuitry”. That is, functions of each functional element of the circuit quality confirmation apparatus 10 are enabled by the processing circuitry.

As for the circuit quality confirmation apparatus 10 according to other embodiments, the configuration may be in a same configuration as the configuration in the present variation.

### Embodiment 2

Points different from the embodiment mentioned above will mainly be described below while referring to the drawings.

### Description of Configuration

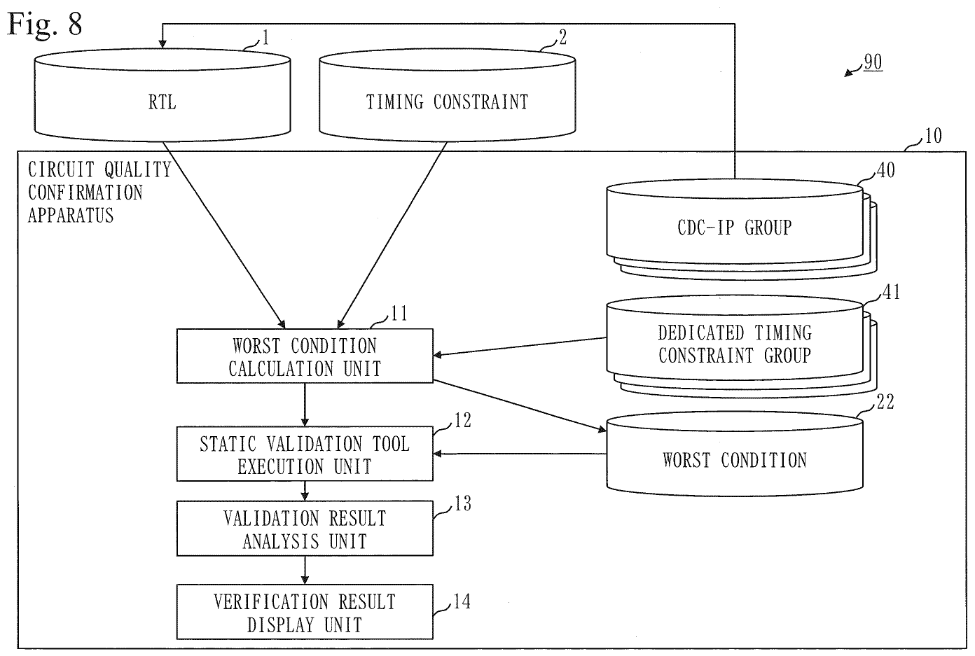

FIG. 8 illustrates an example of a configuration of a circuit quality confirmation system 90 according to the present embodiment. A circuit quality confirmation apparatus 10 according to the present embodiment stores a CDC-IP group 40 instead of the CDC-IP 20, and stores a dedicated timing constraint group 41 instead of the dedicated timing constraint 21.

The CDC-IP group 40 is an aggregate of CDC-IPs that are candidates for replacing the asynchronous clock interface circuit that the RTL 1 includes. Here, a design philosophy of each CDC-IP that the CDC-IP group 40 includes is a same as a design philosophy of the CDC-IP 20.

The circuit quality confirmation apparatus 10 has stored various CDC-IPs 20 in a way that the asynchronous clock interface circuit can appropriately be replaced in accordance with a type of the asynchronous clock interface circuit that the RTL 1 includes. The type of the asynchronous clock interface circuit, as a specific example, is a circuit that transfers a multi-bit signal, a circuit that transfers a single-bit signal, a circuit that transfers a pulse signal, or the like. There is also a different type of asynchronous clock interface circuit that is in accordance with timing, a method, or the like of a delivery of a signal. The RTL 1 and the CDC-IP 20 according to the present embodiment are circuits that are in accordance with the type of the asynchronous clock interface circuit.

Each dedicated timing constraint of the dedicated timing constraint group 41 is a timing constraint corresponding to each CDC-IP of the CDC-IP group 40. The number of dedicated timing constraints that the dedicated timing constraint group 41 includes is a same as the number of CDC-IPs that the CDC-IP group 40 includes.

### Description of Operation

Operation of the circuit quality confirmation apparatus 10 according to the present embodiment is basically a same as the operation of the circuit quality confirmation apparatus 10 according to Embodiment 1. Among the operation of the circuit quality confirmation apparatus 10 according to the present embodiment, parts different from the operation of the circuit quality confirmation apparatus 10 according to Embodiment 1 will mainly be described below.

### (Step S11: Circuit Generation Process)

In the present step, the embedded circuit 23 is generated by selecting from the CDC-IP group 40, a CDC-IP that is suitable for the asynchronous clock interface circuit that the RTL 1 includes, and then embedding in the RTL 1, the CDC-IP that is selected instead of the CDC-IP 20. In the present step, the embedded constraint 24 is generated by selecting from the dedicated timing constraint group 41, a dedicated timing constraint corresponding to the CDC-IP that is selected, and then embedding in the timing constraint 2, the dedicated timing constraint that is selected instead of the dedicated timing constraint 21.

In the present step, in a case where the RTL 1 includes a plurality of asynchronous clock interface circuits, above-mentioned processes are executed for each asynchronous clock interface circuit that the RTL 1 includes.

### Description of Effect of Embodiment 2.

As described above, according to the present embodiment, an appropriate CDC-IP can be selected in accordance with the type of the asynchronous clock interface circuit that the RTL 1 includes.

### Embodiment 3

Points different from the embodiments mentioned above will mainly be described below while referring to the drawings.

### Description of Configuration

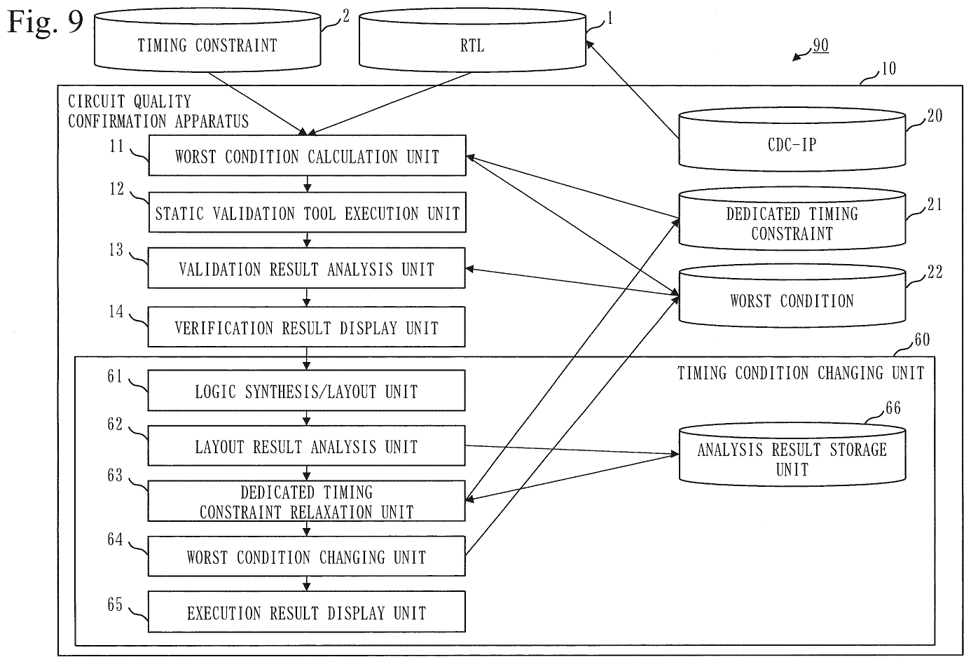

FIG. 9 illustrates an example of a configuration of a circuit quality confirmation system 90 according to the present embodiment. A circuit quality confirmation apparatus 10 according to the present embodiment further includes a timing condition changing unit 60 as illustrated in FIG. 9.

The timing condition changing unit 60, as illustrated in FIG. 9, includes a logic synthesis/layout unit 61, a layout result analysis unit 62, a dedicated timing constraint relaxation unit 63, a worst condition changing unit 64, an execution result display unit 65, and an analysis result storage unit 66. In a case where the static validation tool execution unit 12 verified that there is no issue in the quality of the embedded circuit 23, and in a case where there is a violation of the dedicated timing constraint 21 in the post-layout netlist corresponding to the embedded circuit 23, the timing condition changing unit 60 generates a revised dedicated timing constraint by relaxing an upper limit value of a delay value of the dedicated timing constraint 21 in accordance with an asynchronous clock interface path and a delay value corresponding to the violation, and revises the worst condition 22 in accordance with a difference between the dedicated timing constraint 21 and the revised dedicated timing constraint. Here, the revised dedicated timing constraint is generated in a way that a probability of a violation of the revised dedicated timing constraint happening in the post-layout netlist is lower than a probability of a violation of the dedicated timing constraint 21 happening in the post-layout netlist. A revision of the worst condition 22 is executed in accordance with timing that changed by the dedicated timing constraint 21 being revised.

An aim of the timing condition changing unit 60 is to reduce a load of a tool that executes the layout by relaxing a timing constraint. As a specific example, in a circuit corresponding to the timing chart illustrated in FIG. 3, depending on time taken for propagation of data, (the number of flip-flop stages)+a wiring delay+a different condition (a phase and the like), around five cycles of a subsequent stage clock are necessary as an enable period. As the wiring delay becomes larger, the enable period that is necessary becomes more extended. Here, in a case where an enable period that is to be latched can be made longer, the timing constraint can be relaxed. Therefore, the timing condition changing unit 60 relaxes the Maxdelay constraint of the dedicated timing constraint 21 in a case where it is determined that the tool cannot execute the layout due to the timing constraint being strict. A specification of a generation circuit of the enable to make the enable period longer, as a specific example, is a specification in which data (dat_in) that is inputted in the circuit illustrated in FIG. 2 is latched by an enable (ena_in), and the data that is inputted is stretched during when the enable is valid. As a timing constraint at layout time, a timing constraint is regarded as existent in which a delay between the wiring 32 and the wiring 33 is kept within one cycle.

The logic synthesis/layout unit 61 executes generation of a netlist and arrangement and wiring by executing a logic synthesis and a layout of a circuit with the embedded circuit 23 and the embedded constraint 24 as input. The logic synthesis/layout unit 61 may be a commercially available logic synthesis/layout tool, and as a specific example, is a tool indicated in [Reference 1]. A logic synthesis/layout tool may be installed in the circuit quality confirmation apparatus 10 or may be installed in a different apparatus.

### [Reference 1]

Nihon Synopsys G.K., “IC Compiler II”, [online], [Searched on Apr. 19, 2022], Internet <URL: https://www.synopsys.com/ja-jp/implementation-and-signoff/physical-implementation/ic-compiler.html>

The layout result analysis unit 62 confirms existence or non-existence of the violation of the dedicated timing constraint 21 by confirming an execution result of the logic synthesis/layout unit 61 using an STA (Static Timing Analysis) tool and the like. In a case where the violation of the dedicated timing constraint 21 is in the execution result, the layout result analysis unit 62 stores in the analysis result storage unit 66, an asynchronous clock interface path and a delay value corresponding to the violation.

The dedicated timing constraint relaxation unit 63 relaxes the dedicated timing constraint 21 based on an execution result of the layout result analysis unit 62. Timing constraint relaxation is to change the dedicated timing constraint 21. Specifically, the dedicated timing constraint relaxation unit 63 resets the MaxDelay constraint based on the delay value corresponding to the violation for the asynchronous clock interface path that the layout result analysis unit 62 stored. At this time, the dedicated timing constraint relaxation unit 63 operates in a unit of a clk_dst cycle, balancing with a timing condition changing unit 70 to be mentioned below. As a specific example, when clk_dst is 2ns cycle, a delay of the MaxDelay constraint that the dedicated timing constraint 21 indicates is 2ns, and in a case where the delay value of the asynchronous clock interface path becomes 3ns as a result of executing the logic synthesis and layout tool, the dedicated timing constraint relaxation unit 63 changes the MaxDelay constraint corresponding to the asynchronous clock interface path to 4ns.

The worst condition changing unit 64 changes the worst condition 22 in accordance with the relaxation that the dedicated timing constraint relaxation unit 63 executed.

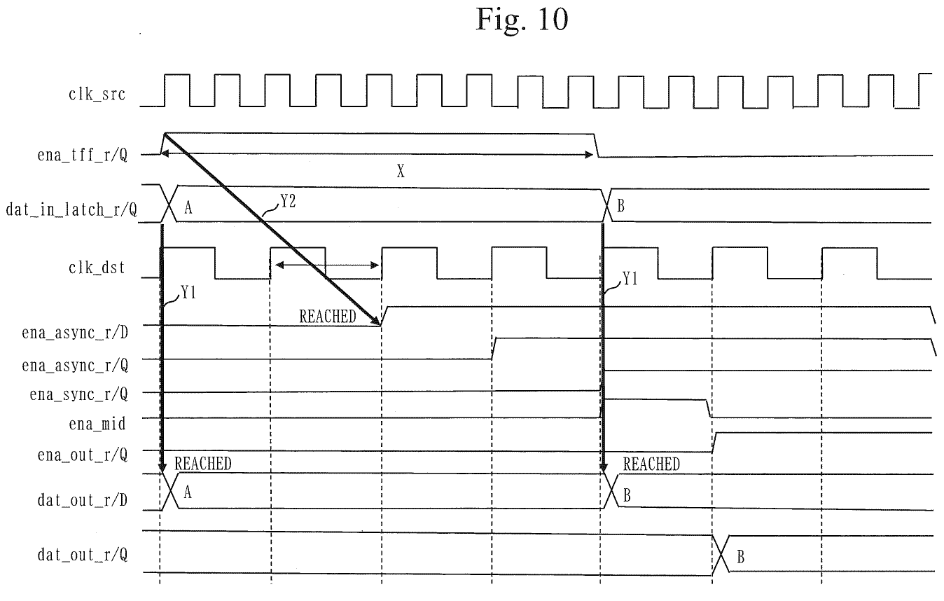

FIG. 10 is a specific example illustrating a case where a delay value of the enable signal (ena_tff_r/Q) has become one cycle's worth of clk_dst larger from timing that data could barely be latched in a subsequent stage of the enable signal (ena_tff_r/Q) illustrated in FIG. 4. In a case where the MaxDelay constraint that the dedicated timing constraint 21 indicates is relaxed as mentioned above, there is a possibility of a maximum value of the delay value increasing in an amount of relaxation. It can be understood that in FIG. 10, since propagation of the enable signal (ena_tff_r/Q) is delayed because the delay value increased in one cycle's worth of clk_dst by relaxation of the dedicated timing constraint 21, data B that is a next piece of data reached at a time of outputting data (dat_out_r/Q) and data A is missed.

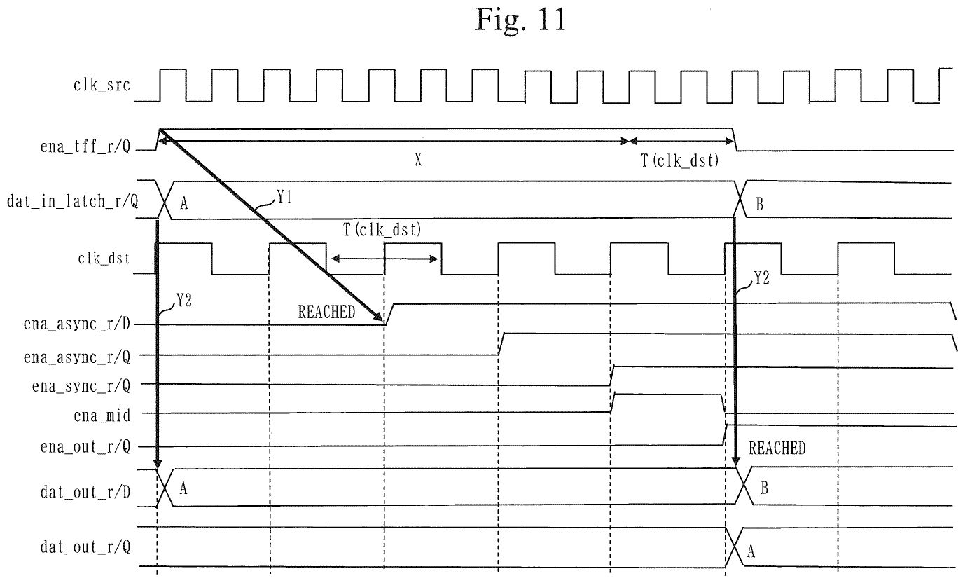

FIG. 11 is a diagram illustrating a case where the holding period of the enable signal (ena_tff_r/Q) is extended by one cycle's worth of clk_dst from the holding period illustrated in FIG. 10. As can be understood from FIG. 10 and FIG. 11, in a case where the delay increased by one cycle's worth of clk_dst, extending the holding period of the enable signal (ena_tff_r/Q) by one cycle's worth of clk_dst is necessary. Thus, the worst condition changing unit 64 extends the holding period of the enable signal (ena_tff_r/Q) that is set in the worst condition 22 in an amount that the dedicated timing constraint relaxation unit 63 relaxed.

The execution result display unit 65 displays a relaxation result of the dedicated timing constraint relaxation unit 63 and a change result of the worst condition changing unit 64.

### Description of Operation

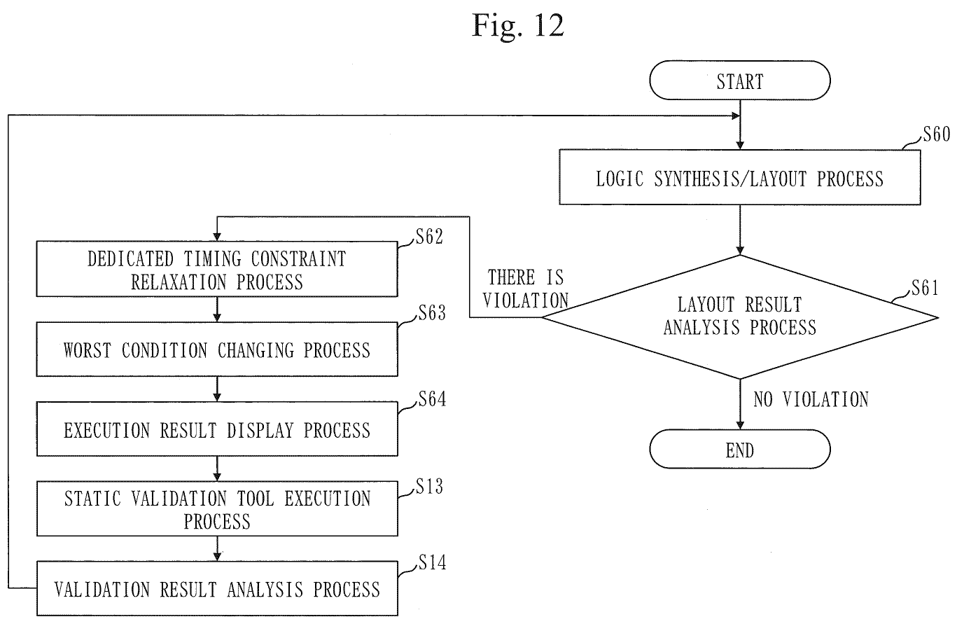

FIG. 12 illustrates an example of operation of the circuit quality confirmation apparatus 10. The operation of the circuit quality confirmation apparatus 10 will be described using FIG. 12.

### (Step S60: Logic Synthesis/Layout Process)

The logic synthesis/layout unit 61 executes a logic synthesis and a layout with a CDC-IP 20 corresponding to the asynchronous clock interface circuit that the embedded circuit 23 includes and the embedded constraint 24 as input.

### (Step S61: Layout Result Analysis Process)

The layout result analysis unit 62 verifies whether or not there is a violation of the dedicated timing constraint 21 as a result of executing the logic synthesis/layout process. As a specific example, in a case where the dedicated timing constraint 21 is the MaxDelay constraint, a violation means that a path that exceeds a delay value that is designated exists.

The circuit quality confirmation apparatus 10 ends the process of the present flowchart since validation ends in a case where there is no violation. In a case where there is a violation, the layout result analysis unit 62 stores in the analysis result storage unit 66, an asynchronous clock interface path and a delay value corresponding to the violation, and the circuit quality confirmation apparatus 10 proceeds step S62.

### (Step S62: Dedicated Timing Constraint Relaxation Process)

The dedicated timing constraint relaxation unit 63 revises the dedicated timing constraint 21 in accordance with an asynchronous clock interface path and a delay value corresponding to a timing violation based on the CDC-IP 20, the dedicated timing constraint 21, and the asynchronous clock interface path and the delay value that the analysis result storage unit 66 has stored.

### (Step S63: Worst Condition Changing Process)

The worst condition changing unit 64 revises the worst condition 22. Specifically, the worst condition changing unit 64 extends a holding period condition of the enable signal (ena_tff_r/Q) in accordance with a numerical value of the dedicated timing constraint 21 that is revised (relaxed) in step S62.

### (Step S64: Execution Result Display Process)

The execution result display unit 65 displays results of what each of the dedicated timing constraint relaxation unit 63 and the worst condition changing unit 64 executed.

### Description of Effect of Embodiment 3.

As described above, according to the present embodiment, in a case where there is a violation of the dedicated timing constraint 21 as a result of executing the logic synthesis and the layout, validating the RTL again and executing the logic synthesis and the layout can be done without executing a timing improvement such as altering the RTL, a manual layout, or the like by executing an analysis of a timing result automatically, and revising the dedicated timing constraint 21 and the worst condition 22, a manual layout, or the like. Thus, according to the present embodiment, a possibility of reworking of design work, layout work, or the like occurring can be reduced.

### Embodiment 4

Points different from the embodiments mentioned above will mainly be described below while referring to the drawings.

### Description of Configuration

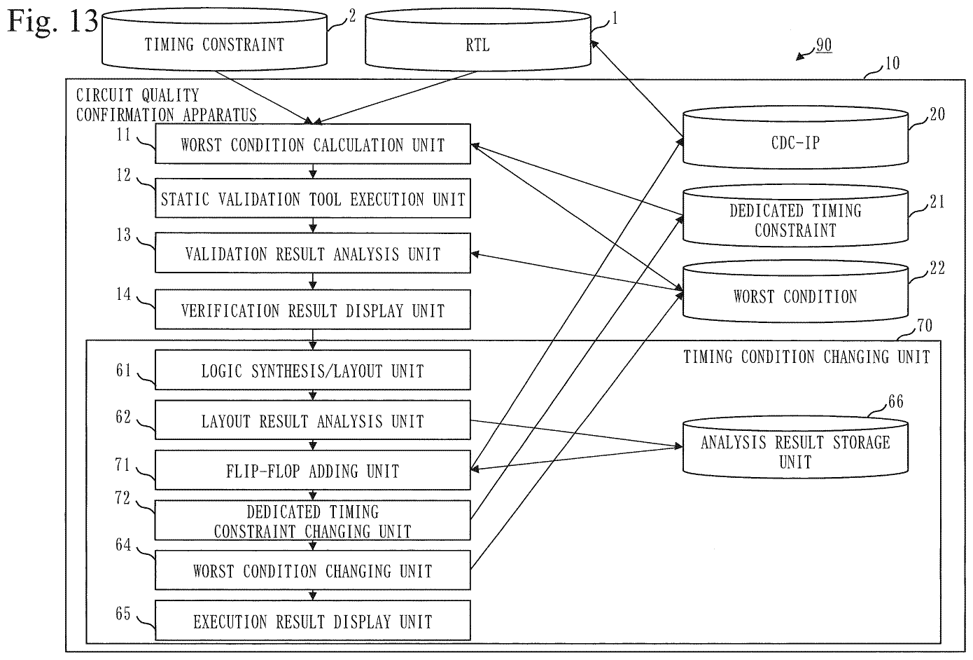

FIG. 13 illustrates an example of a configuration of a circuit quality confirmation system 90 according to the present embodiment. A circuit quality confirmation apparatus 10 according to the present embodiment, as illustrated in FIG. 13, further includes the timing condition changing unit 70.

The timing condition changing unit 70 includes the logic synthesis/layout unit 61, the layout result analysis unit 62, a flip-flop adding unit 71, a dedicated timing constraint changing unit 72, the worst condition changing unit 64, the execution result display unit 65, and the analysis result storage unit 66. The timing condition changing unit 70, in a case where the static validation tool execution unit 12 verified that there is no issue in the quality of the embedded circuit 23, and in a case where there is a violation of the dedicated timing constraint 21 in the post-layout netlist corresponding to the embedded circuit 23, adds a flip-flop to the dedicated circuit in accordance with an asynchronous clock interface path and a delay value corresponding to the violation. The timing condition changing unit 70 revises the worst condition 22 in accordance with timing that changed by the flip-flop being added to the dedicated circuit.

In Embodiment 3, the timing condition changing unit 60 reduces the possibility of the embedded circuit 23 violating the dedicated timing constraint 21 by relaxing an upper limit of a delay value of the post-layout netlist by changing the dedicated timing constraint 21. Here, since wiring becomes short by inserting a flip-flop for a signal line whose delay is large, a delay in the post-layout netlist can be eased.

In Embodiment 3, the dedicated timing constraint 21 is changed by changing the value of the MaxDelay constraint in the dedicated timing constraint relaxation unit 63.

In the present embodiment, since a layout condition is relaxed by inserting a flip-flop in the embedded circuit 23, the numerical value of the dedicated timing constraint 21 is not necessary to be changed. Since a name of an asynchronous interface path, however, changes by inserting the flip-flop, a starting point or an ending point of the MaxDelay constraint is necessary to be changed.

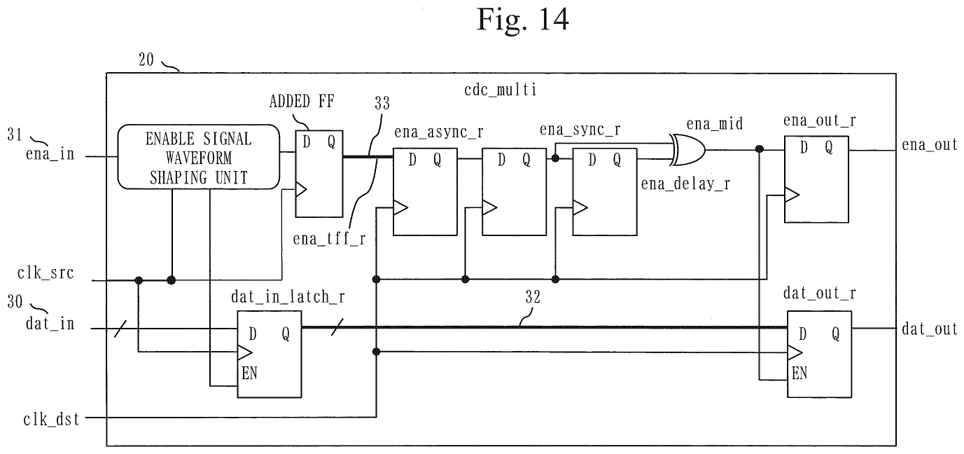

FIG. 14 illustrates an example according to Embodiment 4. In FIG. 14, a case where a flip-flop is inserted in the wiring 33 of the CDC-IP 20 in a case where there is a violation in the MaxDelay constraint set in the wiring 33 illustrated in FIG. 2 after the layout is illustrated. The flip-flop adding unit 71 shortens wiring of a path and mitigates a violation of the dedicated timing constraint 21 that occurs when a next logic synthesis and layout are executed by inserting a flip-flop in a CDC-IP path in which there is a violation of the dedicated timing constraint 21. Similarly, the flip-flop adding unit 71 may insert a flip-flop in the wiring 32, and may insert a flip-flop in both the wiring 33 and the wiring 32.

In FIG. 14, since the flip-flop adding unit 71 added a flip-flop in a preceding stage, propagation of an enable signal in the subsequent stage is delayed by one cycle's worth with respect to propagation of an enable signal in the preceding stage. Consequently, in a case where a flip-flop is added, the worst condition changing unit 64 additionally takes one cycle's worth of a clock of a preceding stage as a delay in the dedicated timing constraint 21 relating to inter-path into consideration. Here, in a case where the clock of the preceding stage is faster than a clock of a subsequent stage as in a specific example, an effect with respect to timing is less in a case where the flip-flop is added in the preceding stage. In a case where there is little difference between a frequency in the preceding stage and a frequency in the subsequent stage, in a case where there is an issue in adding a flip-flop in the preceding stage, or the like, the flip-flop adding unit 71 may add a flip-flop in the subsequent stage.

### Description of Effect of Embodiment 4.

As described above, according to the present embodiment, in a case where there is a violation of the dedicated timing constraint 21 as a result of executing the logic synthesis and the layout, a possibility of a violation of the dedicated timing constraint 21 occurring at a time of executing the logic synthesis and the layout again can be reduced by shortening an inter-path wiring distance by inserting a flip-flop.

According to the present embodiment, re-validation and the logic synthesis and the layout can be executed by revising the worst condition 22 without executing a different timing improvement.

### Other Embodiments

A free combination of each embodiment mentioned above, or a variation of any element of each embodiment, or omitting of any element in each embodiment is possible.

The embodiments are not to be limited to the embodiments indicated in Embodiments 1 to 4, and various changes are possible to be made as necessary. Procedures described using the flowcharts and the like may suitably be changed.

### REFERENCE SIGNS LIST

1: RTL; 2: timing constraint; 10: circuit quality confirmation apparatus; 11: worst condition calculation unit; 12: static validation tool execution unit; 13: validation result analysis unit; 14: verification result display unit; 20: CDC-IP; 21: dedicated timing constraint; 22: worst condition; 23: embedded circuit; 24: embedded constraint; 30, 31: signal; 32, 33: wiring; 40: CDC-IP group; 41: dedicated timing constraint group; 51: processor; 52: memory; 53: auxiliary storage device; 54: input/output IF; 55: communication device; 58: processing circuit; 59: signal line; 60: timing condition changing unit; 61: logic synthesis/layout unit; 62: layout result analysis unit; 63: dedicated timing constraint relaxation unit; 64: worst condition changing unit; 65: execution result display unit; 66: analysis result storage unit; 70: timing condition changing unit; 71: flip-flop adding unit; 72: dedicated timing constraint changing unit; 90: circuit quality confirmation system.

1. A circuit quality confirmation apparatus comprising:
processing circuitry to:
calculate, using a dedicated timing constraint that indicates an upper limit of a wiring delay value of an asynchronous clock interface path in an embedded circuit in which a dedicated circuit that is an asynchronous clock interface circuit where an input/output waveform of a signal is uniquely defined in accordance with a timing condition that is set and that is an asynchronous clock interface circuit that includes an asynchronous clock interface path is embedded, a worst condition that is a timing condition that is a theoretical limit of data that can be taken in in a subsequent stage of the asynchronous clock interface path in the embedded circuit, and that is a timing condition that is calculated based on a wiring delay that is expected to occur in a post-layout netlist equivalent to a circuit that is generated by executing a layout corresponding to the embedded circuit, and delay time that occurs by at least one of a phase relationship between asynchronous clocks, a clock jitter, a clock skew, a setup time, and a hold time in the dedicated circuit, and
validate quality of the embedded circuit by executing a validation tool that statically validates the quality of the embedded circuit using the embedded circuit, a timing constraint of the embedded circuit, and a worst condition that is calculated, wherein
each of the dedicated circuit that is the asynchronous clock interface circuit and the embedded circuit is a circuit expressed by a hardware description language.

2. The circuit quality confirmation apparatus according to claim 1, wherein
the embedded circuit is a circuit to be implemented in an integrated circuit.

3. The circuit quality confirmation apparatus according to claim 1, wherein
the processing circuitry
generates the embedded circuit by replacing a target asynchronous clock interface circuit that is an asynchronous clock interface circuit that a target circuit includes with a dedicated circuit that is in accordance with an interface format of the target asynchronous clock interface circuit.

4. The circuit quality confirmation apparatus according to claim 2, wherein
the processing circuitry
generates the embedded circuit by replacing a target asynchronous clock interface circuit that is an asynchronous clock interface circuit that a target circuit includes with a dedicated circuit that is in accordance with an interface format of the target asynchronous clock interface circuit.

5. The circuit quality confirmation apparatus according to claim 1, wherein
the processing circuitry
in a case where the processing circuitry verified that there is no issue in quality of the embedded circuit, and in a case where there is a violation of the dedicated timing constraint in the post-layout netlist, generates a revised dedicated timing constraint by relaxing an upper limit value of a delay value of the dedicated timing constraint in accordance with an asynchronous clock interface path and a delay value corresponding to the violation, and revises the worst condition in accordance with a difference between the dedicated timing constraint and the revised dedicated timing constraint, and the revised dedicated timing constraint is generated in a way that a probability of a violation of the revised dedicated timing constraint happening in the post-layout netlist is lower than a probability of a violation of the dedicated timing constraint happening in the post-layout netlist.

6. The circuit quality confirmation apparatus according to claim 2, wherein
the processing circuitry
in a case where the processing circuitry verified that there is no issue in quality of the embedded circuit, and in a case where there is a violation of the dedicated timing constraint in the post-layout netlist, generates a revised dedicated timing constraint by relaxing an upper limit value of a delay value of the dedicated timing constraint in accordance with an asynchronous clock interface path and a delay value corresponding to the violation, and revises the worst condition in accordance with a difference between the dedicated timing constraint and the revised dedicated timing constraint, and
the revised dedicated timing constraint is generated in a way that a probability of a violation of the revised dedicated timing constraint happening in the post-layout netlist is lower than a probability of a violation of the dedicated timing constraint happening in the post-layout netlist.

7. The circuit quality confirmation apparatus according to claim 3, wherein
the processing circuitry
in a case where the processing circuitry verified that there is no issue in quality of the embedded circuit, and in a case where there is a violation of the dedicated timing constraint in the post-layout netlist, generates a revised dedicated timing constraint by relaxing an upper limit value of a delay value of the dedicated timing constraint in accordance with an asynchronous clock interface path and a delay value corresponding to the violation, and revises the worst condition in accordance with a difference between the dedicated timing constraint and the revised dedicated timing constraint, and
the revised dedicated timing constraint is generated in a way that a probability of a violation of the revised dedicated timing constraint happening in the post-layout netlist is lower than a probability of a violation of the dedicated timing constraint happening in the post-layout netlist.

8. The circuit quality confirmation apparatus according to claim 4, wherein
the processing circuitry
in a case where the processing circuitry verified that there is no issue in quality of the embedded circuit, and in a case where there is a violation of the dedicated timing constraint in the post-layout netlist, generates a revised dedicated timing constraint by relaxing an upper limit value of a delay value of the dedicated timing constraint in accordance with an asynchronous clock interface path and a delay value corresponding to the violation, and revises the worst condition in accordance with a difference between the dedicated timing constraint and the revised dedicated timing constraint, and
the revised dedicated timing constraint is generated in a way that a probability of a violation of the revised dedicated timing constraint happening in the post-layout netlist is lower than a probability of a violation of the dedicated timing constraint happening in the post-layout netlist.

9. The circuit quality confirmation apparatus according to claim 1, wherein
the processing circuitry
in a case where the processing circuitry verified that there is no issue in quality of the embedded circuit, and in a case where there is a violation of the dedicated timing constraint in the post-layout netlist corresponding to the embedded circuit, adds a flip-flop to the dedicated circuit in accordance with an asynchronous clock interface path and a delay value corresponding to the violation, and revises the worst condition in accordance with timing that changed by adding the flip-flop to the dedicated circuit.

10. The circuit quality confirmation apparatus according to claim 2, wherein
the processing circuitry
in a case where the processing circuitry verified that there is no issue in quality of the embedded circuit, and in a case where there is a violation of the dedicated timing constraint in the post-layout netlist corresponding to the embedded circuit, adds a flip-flop to the dedicated circuit in accordance with an asynchronous clock interface path and a delay value corresponding to the violation, and revises the worst condition in accordance with timing that changed by adding the flip-flop to the dedicated circuit.

11. The circuit quality confirmation apparatus according to claim 3, wherein
the processing circuitry
in a case where the processing circuitry verified that there is no issue in quality of the embedded circuit, and in a case where there is a violation of the dedicated timing constraint in the post-layout netlist corresponding to the embedded circuit, adds a flip-flop to the dedicated circuit in accordance with an asynchronous clock interface path and a delay value corresponding to the violation, and revises the worst condition in accordance with timing that changed by adding the flip-flop to the dedicated circuit.

12. The circuit quality confirmation apparatus according to claim 4, wherein
the processing circuitry
in a case where the processing circuitry verified that there is no issue in quality of the embedded circuit, and in a case where there is a violation of the dedicated timing constraint in the post-layout netlist corresponding to the embedded circuit, adds a flip-flop to the dedicated circuit in accordance with an asynchronous clock interface path and a delay value corresponding to the violation, and revises the worst condition in accordance with timing that changed by adding the flip-flop to the dedicated circuit.

13. A circuit quality confirmation method comprising:
calculating, using a dedicated timing constraint that indicates an upper limit of a wiring delay value of an asynchronous clock interface path in an embedded circuit in which a dedicated circuit that is an asynchronous clock interface circuit where an input/output waveform of a signal is uniquely defined in accordance with a timing condition that is set and that is an asynchronous clock interface circuit that includes an asynchronous clock interface path is embedded, a worst condition that is a timing condition that is a theoretical limit of data that can be taken in in a subsequent stage of the asynchronous clock interface path in the embedded circuit, and that is a timing condition that is calculated based on a wiring delay that is expected to occur in a post-layout netlist equivalent to a circuit that is generated by executing a layout corresponding to the embedded circuit, and delay time that occurs by at least one of a phase relationship between asynchronous clocks, a clock jitter, a clock skew, a setup time, and a hold time in the dedicated circuit; and
validating quality of the embedded circuit by executing a validation tool that statically validates quality of the embedded circuit using the embedded circuit, a timing constraint of the embedded circuit, and a worst condition that is calculated, wherein
each of the dedicated circuit that is the asynchronous clock interface circuit and the embedded circuit is a circuit expressed by a hardware description language.
